(19) United States
(12) Patent Application Publication
(10) Pub. No.: US 2014/0203462 A1
(43) Pub. Date: Jul. 24, 2014

(54) METHOD OF MANUFACTURING PLATE WORKPIECE WITH SURFACE MICROSTRUCTURES

(71) Applicant: CHAO-WEI METAL INDUSTRIAL CO. LTD, Taichung City (TW)

(72) Inventors: Yung-Yuan Liao, Taichung City (TW); Chao-Wei Liao, Taichung City (TW)

(73) Assignee: CHAO-WEI METAL INDUSTRIAL CO. LTD, Taichung City (TW)

(21) Appl. No.: 13/747,233

(22) Filed: Jan. 22, 2013

(51) Int. Cl. G02B 7/00; B29C 59/02

(52) U.S. Cl. CPC G02B 7/003; B29C 59/02
USPC 264/1.24; 264/293

(57) ABSTRACT

A method of manufacturing a plate workpiece with surface microstructures is provided. Before press-molding, a preform is placed between a first mold with a pattern and a second mold, and is disposed on the second mold. Next, the first mold and the second mold are heated to a transition temperature of the preform, and then pressed against the preform to impress the pattern onto the preform to obtain a patterned preform. Finally, the patterned preform is cooled with the second mold and shrunk to obtain the plate workpiece with surface microstructures. Since the patterned preform is uniformly cooled from bottom to top by thermal conduction, the temperature field is isothermal in a horizontal distribution. Therefore, a plate workpiece with high accuracy surface microstructures is obtained, and is useful for carrying multiple optical fibers in optical communication.

### BACKGROUND OF THE INVENTION

1. Field of the Invention

The present invention relates to a method of manufacturing a plate workpiece with surface microstructures, and more particularly to a method of manufacturing an optical fiber carrying workpiece.

2. Description of the Prior Arts

Optical fibers are fine fibers mainly composed of a core, a clad and a protective coating layer from inner to outer in sequence to ensure light is kept in the fibers by total internal reflection, and are useful for long-distance optical communication. The clad has an outer diameter about 125 micrometers; however, the core has an outer diameter only about 10 micrometers to 62.5 micrometers. With the micro scale, a high precision alignment is thus required at optical interconnections for reducing the connection loss through multiple optical fibers, thereby successfully transmitting the light.

A passive alignment is usually applied to improve the efficiency of multiple optical fibers connection. Parts of the optical fibers carried on an optical fiber carrying workpiece marked with alignment marks are easily positioned and aligned with other optical fibers carried on another carrying workpiece or an optical element, such as a light emitting element, a light accepting element or an optical waveguide, by their corresponding alignment marks. However, an optical fiber carrying workpiece with high accuracy surface microstructures is required for attaining a sufficient alignment precision to reduce the optical loss at optical interconnections.

As shown in FIG. 6, two optical fiber carrying workpieces 61, 62 respectively have multiple V-shaped grooves formed thereon for carrying multiple optical fibers 611, 612, 621, 622. When two optical fiber carrying workpieces 61, 62 having surface microstructures with high accuracy (i.e., the V-shaped grooves are arranged parallel to each other and have an identical shape and size with each other) are used, the optical fiber 611 carried on the optical fiber carrying workpiece 61 is precisely aligned with another optical fiber 621 carried on another optical fiber carrying workpiece 62 at optical interconnection. Hence, the connection loss occurring at optical interconnection is largely reduced.

However, if the grooves of the optical fiber carrying workpiece 61 are not arranged parallel to each other, the optical fiber 612 disposed in the oblique groove is misaligned to others. The misaligned optical fiber 612 cannot be precisely aligned with another optical fiber 622 carried on another optical fiber carrying workpiece 62, such that serious connection loss occurs at optical interconnection and largely reduces the effective distance of optical communication.

Furthermore, if the V-shaped grooves are disposed with slight displacement, two optical fibers respectively carried on two optical fiber carrying workpieces with parallel-aligned grooves still cannot be precisely aligned.

As shown in FIG. 7, optical fibers 711, 712 carried on an optical fiber carrying workpiece 71 and optical fibers 721, 722 carried on another optical fiber carrying workpiece 72 are aligned parallel to each other. However, if two optical fiber carrying workpieces 71, 72 have surface microstructures with different sizes or intervals, as shown in FIG. 7, intervals between every two adjacent grooves of the surface microstructures are not identical; one optical fiber 712 does have a slight displacement with the other corresponding optical fiber 722 though the optical fiber 711 is precisely aligned with the optical fiber 721. Serious connection loss still occurs at optical interconnection between these optical fibers 712, 722, thereby largely reducing the effective distance of optical communication.

Hence, an optical fiber carrying workpiece with high accuracy surface microstructures is required in passive alignment for reducing the connection loss at optical interconnection. The efficiency of connecting a large amount of optical fibers is also improved by this way.

A conventional method of manufacturing a plate workpiece typically comprises the steps of: heating a mold and a preform, pressing the preform, parting the preform from the mold and cooling the preform from periphery of the preform. However, cooling the preform from each outer surface transforms the temperature field of the preform such that the temperature field is not isothermal in horizontal distribution. As shown in FIG. 8, a circular pattern is mapped in the top temperature field, indicating that the temperature differences between the outermost surface microstructures and the central surface microstructures are large. Thus, serious deformations and warps occur in the outermost surface microstructures, thereby deteriorating the geometric accuracy of the surface microstructure in the plate workpiece.

Besides, the variance of temperature between the outer surface microstructures and the central surface microstructures becomes more serious when the number of grooves formed on the plate workpiece is increased. Thus, the error variances of width and of interval between those grooves are more than 1 micrometer. The problems show that a conventional method fails to produce a plate workpiece having surface microstructures with high accuracy and high grooves quantity.

To overcome the shortcomings, the present invention provides a method of manufacturing a plate workpiece with surface microstructures to mitigate or obviate the aforementioned problems.

### SUMMARY OF THE INVENTION

The primary objective of the present invention is to effectively improve the accuracy of the surface microstructures formed in a plate workpiece. Hence, the plate workpiece with surface microstructures applied to carrying multiple optical fibers can largely reduce the connection loss occurring in the optical interconnections

To achieve the aforementioned objectives, the present invention provides a method of manufacturing a plate workpiece with surface microstructures, comprising the steps of:

(A) providing a press-molding apparatus, having: a first mold having a first surface and a pattern formed on the first surface of the first mold; and a second mold facing to the first surface of the first mold;

(B) placing a preform between the first mold and the second mold and on the second mold;

(C) heating the first mold and the second mold to a temperature at which the preform is capable of being press-molded;

(D) pressing the first mold and the second mold against the preform, and thereby impressing the pattern of the first mold onto the preform to obtain a patterned preform, the patterned preform having multiple surface microstructures formed in a surface of the patterned preform in contact with the first mold; and

(E) cooling the second mold and parting the patterned preform from the first mold by shrinkage, so as to obtain the plate workpiece with the surface microstructures.

Since the patterned preform is disposed on the second mold, the patterned preform can be cooled by thermal conduction when the second mold is uniformly cooled only from the surface opposite to the patterned preform in the aforementioned step (E). Thus, the cooled patterned preform has a temperature field remaining isothermal in a horizontal distribution and varying in a vertical distribution, such that the accuracy of the surface microstructures formed on the plate workpiece with surface microstructures is improved.

The term “pattern” as used hereby comprises multiple three-dimensional surface microstructures. A pattern protruding from the first surface of the first mold is impressed onto the preform to obtain a patterned preform. Accordingly, a pattern of the patterned preform corresponds to the pattern of the first mold. More specifically, the three-dimensional surface microstructures formed in the patterned preform are complementary to the three-dimensional surface microstructures formed on the first mold.

The term “accuracy” as used hereby is inversely related to an error variance among the surface microstructures of the patterned preform. The inaccuracy is mostly caused by non-uniform shrinkage during cooling. If the error variance of shrinkage percentage of the outermost surface microstructure differentiates more from that of the central surface microstructure, the uniformity of the shape, size and interval of the surface microstructures formed on the plate workpiece with surface microstructures is worse. In contrast, if the error variance of shrinkage percentage of the outermost surface microstructure differentiates less from that of the central surface microstructure, the uniformity of the shape, size and interval of the surface microstructures formed on the plate workpiece with surface microstructures is better, such that a plate workpiece with high accuracy surface microstructures is obtained.

Preferably, the step of placing a preform between the first mold and the second mold and on the second mold comprises disposing the preform, the first mold and the second mold in a closed chamber, wherein the closed chamber has a pressure not more than 5×10⁻³ torr. Said pressure arrangement prevents the thermal exchange between the heated preform and the gas, including thermal conduction and thermal convection, and ensures the temperature field of the obtained plate workpiece with surface microstructures to remain isothermal in a horizontal distribution. Therefore, the accuracy of the surface microstructures formed on the plate workpiece with surface microstructures is further improved.

According to the method, the preform is made of a material that is capable of being press-molded after heated to a suitable temperature. The suitable temperature is equal to or higher than a transition temperature of the material. The material is, for example, but not limited to, glass, optical glass, polymethylmethacrylate (PMMA), polyethylene terephthalate (PET), polycarbonate (PC), epoxy resin or quartz. Preferably, the preform is made of optical glass. Preferably, in step (C) of the method, the first mold and the second mold are heated by a lamp to a temperature ranging from 350° C. to 700° C., such that the preform is also heated by thermal conduction.

Preferably, the first mold and the second mold are made of a thermal conductive material, for example, tungsten carbide or tool steel.

Preferably, the first surface of the first mold has a centerline average roughness (Ra) less than 20 nanometers.

Preferably, the step of pressing the first mold and the second mold against the preform comprises pressing the first mold and the second mold against the preform isothermally for 60 seconds to 100 seconds, so as to release the internal thermal stress of the heated patterned preform and prevent undesired deformation of surface microstructures. Herein, the thermal stress is produced in the steps of heating and pressing the preform.

Preferably, the second mold has a first surface facing to the first surface of the first mold and a second surface opposite to the first surface of the second mold, and the second mold is cooled only from the second surface thereof.

Preferably, step (E) of the method comprises cooling the second mold with a cooling rate not more than 0.5° C./second, so that the patterned preform disposed on the second mold is capable of being parted from the first mold by shrinkage, and a plate workpiece with fine surface microstructures is obtained.

More preferably, step (E) of the method comprises cooling the first mold with a cooling rate not more than 0.5° C./second as cooling the second mold from its second surface with a cooling rate not more than 0.5° C./second to assist the patterned preform parting from the first mold by shrinkage.

Preferably, the method further comprises step (E′) after step (E): secondary cooling the second mold with a cooling rate ranging from 1.5° C./second to 2° C./second to obtain the plate workpiece with surface microstructures.

Preferably, step (E) and/or step (E′) comprise(s) blowing a cooling gas to the second surface of the second mold uniformly, so as to cool the second mold. Hence, the patterned preform can be uniformly cooled only from a single surface by means of thermal conduction between the patterned preform and the second mold. Preferably, the cooling gas comprises nitrogen, oxygen or their combination, such as air.

Preferably, the plate workpiece with surface microstructure comprises a surface and multiple grooves formed in the surface of the plate workpiece with surface microstructures and extending along a direction and parallel to each other.

Preferably, each groove is consisted of two adjacent sloping surfaces at an acute angle to form a V-shaped groove.

Preferably, the press-molding apparatus further comprises two fixing members disposed on the second mold and respectively at two opposite sides of the preform. Each fixing member has a long axis parallel to the direction of the grooves of the plate workpiece with the surface microstructures. Accordingly, the accuracy of the surface microstructures near sides of the plate workpiece is further improved. In accordance with the present invention, no fixing member is disposed at the ends of the grooves, which ensures that the thermal stress of the plate workpiece can be released through the ends.

Preferably, each fixing member has a surface near the side of the preform and a film coated on the surface of the fixing member, and the film is made of platinum-iridium alloy or diamond-like carbon (DLC).

Preferably, the grooves have a mean width ranging from 105 micrometers to 195 micrometers and a width tolerance ranging from 0.2 micrometers to 0.35 micrometers.

Preferably, the grooves have a mean interval between every two adjacent grooves ranging from 127 micrometers to 250 micrometers and an interval tolerance ranging from 0.2 micrometers to 0.5 micrometers.

Preferably, the plate workpiece with surface microstructures manufactured by the method can be an optical fiber carrying workpiece. Multiple optical fibers can be disposed onto the grooves and carried on the plate workpiece with surface microstructures. Since the method is capable of manufacturing a plate workpiece, which has high accuracy surface microstructures and comprises multiple grooves disposed with a predetermined angle, preferably parallel to each other, the connection loss occurring in the optical interconnections can be effectively reduced by using the plate workpiece with surface microstructures.

Accordingly, the method of manufacturing a plate workpiece with surface microstructures has the following beneficial effects:

1. Since cooling the first mold is directly performed after the pressing step, the patterned preform can be cooled together and successfully parted from the first mold by shrinkage. Therefore, the method produces a plate workpiece with high accuracy surface microstructures and improves the quality of the plate workpiece.

2. Because the second mold is uniformly cooled only from the second surface, the patterned preform disposed on the second mold is shrunk uniformly from bottom to top. The temperature field of the plate workpiece can be isothermal in a horizontal distribution, such that the accuracy of the surface microstructures of the plate workpiece is further improved.

3. When the heating, pressing, cooling and parting steps of the method are performed in a closed vacuum chamber, thermal transfer between the outer surface of the preform and the gas in contact with the outer surface can be largely reduced. The variance in a horizontal temperature field of the cooled patterned preform is effectively reduced, thus the temperature field of the plate workpiece remains isothermal in a horizontal distribution. Moreover, the closed chamber further prevents the first mold and the second mold from oxidation. Hence, the accuracy of the surface microstructures of the plate workpiece is also improved.

4. Two fixing members are used for fixing the patterned preform and increasing the friction between the patterned preform and the second mold, so that the patterned preform is not moved when the first mold is parting from the patterned preform.

5. The produced plate workpiece with surface microstructures can be an optical fiber carrying workpiece. Multiple optical fibers carried on the plate workpiece with surface microstructures are aligned with high precision in the optical interconnections, thus largely reducing the connection loss occurring at the optical interconnections.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the method of manufacturing a plate workpiece with surface microstructures of the present invention;

FIG. 2A is a cross-sectional side view of the press-molding apparatus and a preform before step (C);

FIG. 2B is a cross-sectional side view of the press-molding apparatus and a preform in step (D);

FIG. 2C is a cross-sectional side view of the press-molding apparatus and a produced plate workpiece with surface microstructures after cooling;

FIG. 3 is a graph illustrating the relation of the pressure, temperatures of the first mold and the second mold, the pressing distance of the first mold pressed down against the preform versus time during the process of manufacturing a plate workpiece with surface microstructures;

FIG. 4 is a perspective view of a plate workpiece with surface microstructures;

FIG. 5 is a graph illustrating the temperature field of a plate workpiece with surface microstructures manufactured by the method in accordance with the present invention;

FIG. 6 is a schematic view of connecting multiple optical fibers by using two optical fiber carrying workpieces;

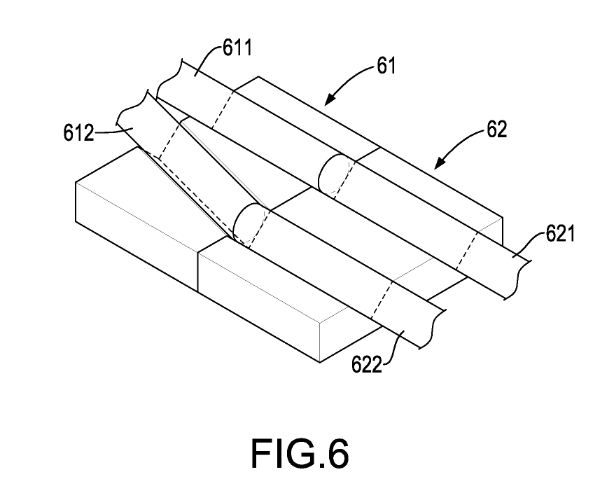

FIG. 7 is another schematic view of connecting multiple optical fibers by using two optical fiber carrying workpieces; and

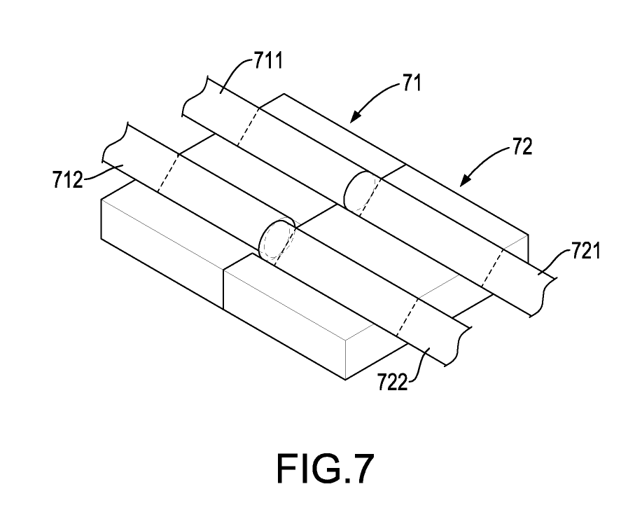

FIG. 8 is a graph illustrating the temperature field of an optical fiber carrying workpiece manufactured by a conventional molding method, which is cooled from periphery thereof.

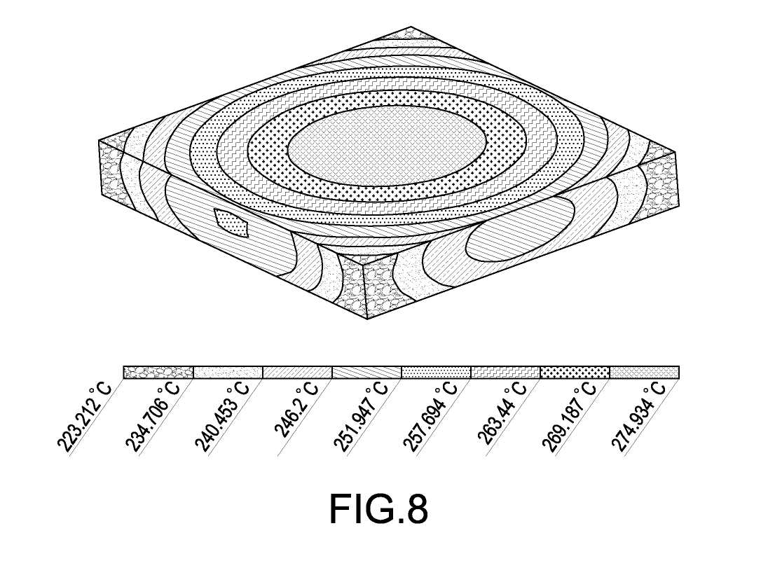

### DETAILED DESCRIPTION OF THE PREFERRED EMBODIMENTS

Hereinafter, one skilled in the arts can easily realize the advantages and effects of a method of manufacturing a plate workpiece with surface microstructures in accordance with the present invention from the following embodiments. The descriptions proposed herein are just preferable embodiments for the purpose of illustrations only, not intended to limit the scope of the invention. Various modifications and variations could be made in order to practice or apply the present invention without departing from the spirit and scope of the invention.

### Embodiment 1

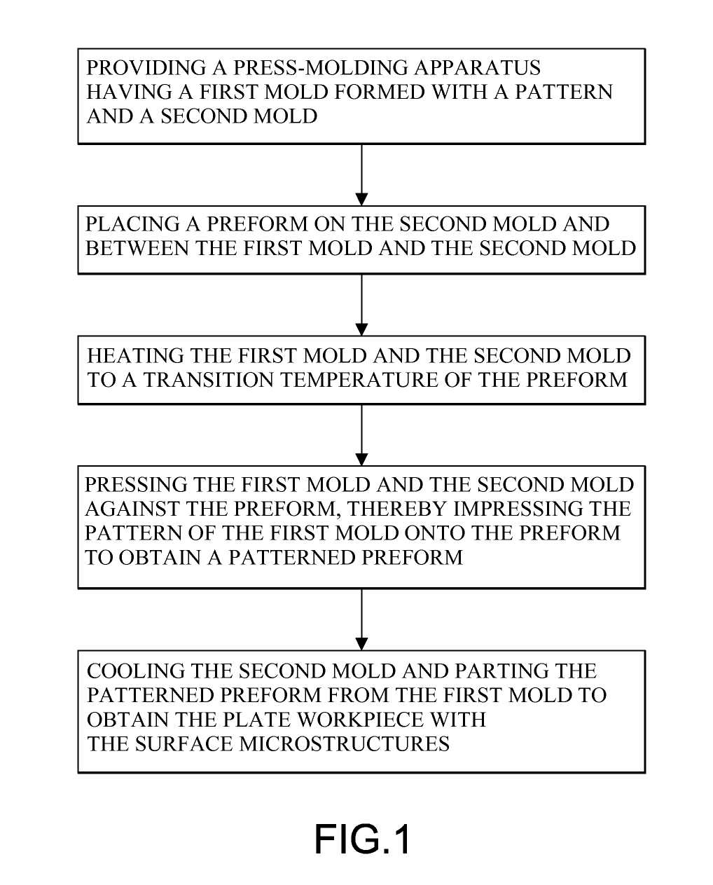

The method of manufacturing a plate workpiece with surface microstructures was implemented as described in detail incorporating the block diagram as shown in FIG. 1.

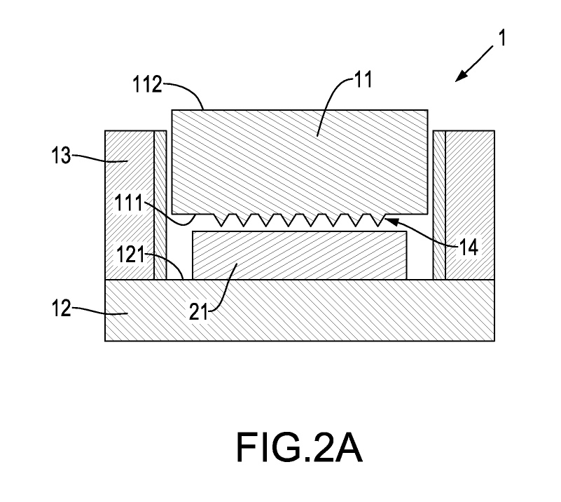

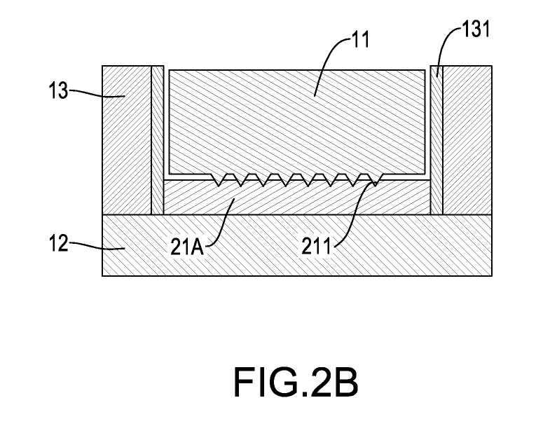

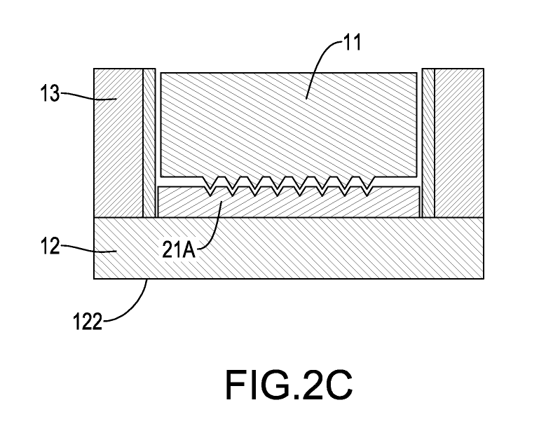

As shown in FIG. 2A, a press-molding apparatus 1 was provided in step (A). The press-molding apparatus comprised a first mold 11, a second mold 12 and two fixing members 13.

The first mold had a first surface 111 and a second surface 112 opposite to the first surface 111. A pattern 14 was formed on the first surface 111 of the first mold 11. The second mold 12 was disposed to face the first surface 111 of the first mold 11 having the pattern 14. Two fixing members 13 were disposed on the second mold 12 and respectively disposed at two opposite sides of the first mold 11.

A preform 21 was provided in step (B). The preform 21 was placed between the first mold 11 and the second mold 12 as well as between two fixing members 13, and is disposed on the second mold 12. The preform 21 was made of optical glass, which enables the preform 21 to be press-molded with a pattern corresponding to the pattern 14 of the first mold 11.

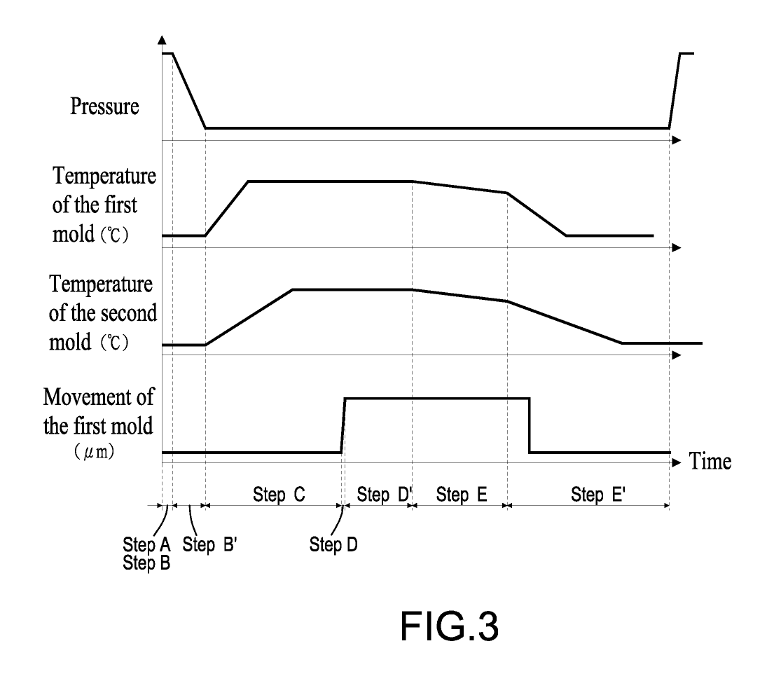

In the present embodiment, the first mold 11, the second mold 12 and the preform 21 were disposed in a closed chamber (not shown in figure). As shown in FIG. 3, step (B′) was performed before the heating, pressing, cooling and parting steps, which were step (C), (D), (E) and (E′) in sequence. The pressure in the closed chamber was reduced to not more than 5×10⁻³ torr in step (B′). Therefore, the thermal transfer by gas in the closed chamber and oxidation of the first mold 11 and the second mold 12 was avoided. The stability of the preform cooled only from a single surface was improved.

Subsequently, the first mold 11 was heated with a heating rate of 5° C./second to about 540° C., and maintained at the temperature for about 100 seconds. Meanwhile, the second mold 12 was heated with a heating rate of 3.86° C./second to about 540° C., and maintained at the temperature for about 80 seconds. Accordingly, the preform 21 disposed on the second mold 12 was heated together to be capable of being press-molded.

In the present embodiment, the first mold 11 and the second mold 12 were made of a thermal conductive material, tungsten carbide. The first surface 111 of the first mold 11 had centerline average roughness less than 20 nanometers.

Then, a load of 150N was applied for pressing the first mold 11 down against the heated preform 21 for about 86.4 micrometers with a pressing rate of 1.5 micrometers/second in step (D). As shown in FIGS. 2A, 2B and 3, the preform 12 was pressed against the first mold 11 and the second mold 12, such that the pattern 14 formed on the first surface 111 of the first mold 11 was impressed onto a top surface of the preform 21 to obtain a patterned preform 21A.

The pattern of the patterned preform 21A comprised multiple grooves 211 formed in a top surface of the patterned preform 21A. Each groove 211 had a width about 105.8 micrometers, and every two adjacent grooves had an interval about 128 micrometers inbetween.

In step (D′), the patterned preform 21A was continuously pressed and the first mold 11 was held at the same position for 100 seconds, so as to release the thermal stress of the patterned preform 21A produced in the heating and pressing steps.

After that, air was used as a cooling gas to blow the second surface 112 of the first mold 11 and the second surface 122 of the second mold 12 uniformly in step (E), so as to cool the first mold 11 only from its second surface 112 and cool the second mold 12 only from its second surface 122 with a cooling rate of 0.5° C./second. In the present embodiment, the first mold 11 and the second mold 12 were cooled down to about 460° C.

Accordingly, the patterned preform 21A was uniformly cooled from bottom to top and together with the second mold 12 by thermal conduction after blowing the air to the second surface 122 of the second mold 12. Further, the contact force between the patterned preform 21A and the first mold 11 was reduced to zero after the first mold 11 was cooled to 490° C. The patterned preform 21A was shrunk and had a smaller volume than before shrinkage. Thus, the patterned preform 21A was capable of parting from the first surface 111 of the first mold 11 and from the fixing members 13 disposed nearby two sides of the patterned perform 21A.

Next, in step (E′), the second mold 12 was secondary cooled from the second surface 122 with a cooling rate of 1.5° C./second, the first mold 11 was also cooled with a cooling rate less than 5° C./second to room temperature. At the same time, the first mold 11 was elevated to the original position.

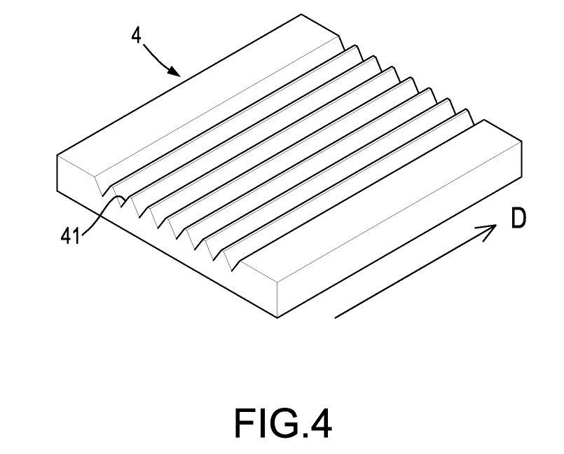

After carrying out cooling of the first mold 11 and the second mold 12, the vacuum of the closed chamber was released. Finally, a plate workpiece with surface microstructures 4 was obtained as shown in FIG. 4. Here, said plate workpiece with surface microstructures 4 was the patterned preform 21A after cooling.

As shown in FIG. 4, the plate workpiece with surface microstructures 4 had multiple grooves 41 formed in the top surface of the plate workpiece 4. The grooves 41 extended along a direction D and parallel to each other. In the present embodiment, the grooves 41 were formed in, but not limited to, a V-shape.

In the present embodiment, the grooves 41 of the plate workpiece 4 had a mean width of 105 micrometers and a width tolerance of 0.1 micrometers. The grooves 41 also had a mean interval of 127 micrometers between every two adjacent grooves 41 and an interval tolerance less than 0.3 micrometers. It demonstrated that the method succeeded in manufacturing a plate workpiece having surface microstructures with high accuracy and high grooves quantity.

With further reference to FIGS. 2B and 4, the heated preform 21 was compressed in a vertical direction and expanded in a horizontal direction after being pressed against the first mold 11. Two fixing members 13 were disposed at two opposite sides of the patterned preform 21A, and each fixing member 13 had a long axis parallel to the direction D of the grooves 211 of the patterned preform 21A. Therefore, the two fixing members disposed at these positions achieved the objectives of controlling the overall size of the patterned preform 21A and improving the accuracy of the surface microstructures of the plate workpiece 4, i.e., reducing the error variance of the widths and interval tolerances to the least.

In the present embodiment, the two fixing members 13 were made of a thermal insulated material. 100 nanometers-thick platinum-iridium alloy films 131 were coated on the surface of the fixing members 13 nearby the patterned preform 21A, so as to provide the fixing members with adhesive-free property. No fixing member was disposed at the ends of the grooves 211, which ensures that the thermal stress of the plate workpiece can be released through the ends.

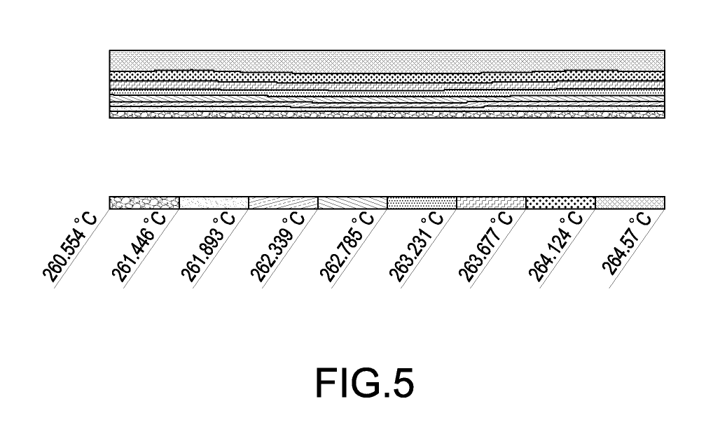

As shown in FIG. 5, the temperature field of the cooled patterned preform remained isothermal in a horizontal distribution and varied in a vertical distribution after cooling the first mold and the second mold only from a single surface of each mold in steps (E) and (E′). Thus, the variance in a horizontal temperature field of the cooled patterned preform was effectively reduced by the present method, thereby obtaining a plate workpiece with high accuracy surface microstructures.

### Embodiment 2

The present embodiment was implemented as described in the aforementioned Embodiment 1. The difference between the Embodiments 1 and 2 was the pattern impressed onto the preform.

In step (D), the preform was disposed between the first mold and the second mold. A load of 280N was applied for pressing the first mold down against the heated preform for about 170 micrometers with a pressing rate of 2.5 micrometers/second to impress the pattern of the first mold onto the preform, and a patterned preform was obtained. In the patterned preform, each groove had a width about 198 micrometers, and every two adjacent grooves had an interval about 252 micrometers inbetween.

After performing a similar cooling step as described in Embodiment 1, the grooves of the plate workpiece had a mean width of 196 micrometers and a width tolerance of 0.1 micrometers. The grooves 41 also had a mean interval of 250 micrometers between every two adjacent grooves and an interval tolerance less than 0.35 micrometers. It demonstrated that the method succeeded in manufacturing a plate workpiece having surface microstructures with high accuracy.

In brief, a patterned preform can be successfully parted from the first mold by shrinkage if the second mold is directly cooled only from the second surface thereof after pressing. As a result, the quality of the produced plate workpiece with surface microstructures is effectively improved, and thereby a plate workpiece with high accuracy surface microstructures is successfully obtained.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of manufacturing a plate workpiece with surface microstructures, comprising the steps of:
(A) providing a press-molding apparatus, having:
a first mold having a first surface and a pattern formed on the first surface of the first mold; and
a second mold facing to the first surface of the first mold;
(B) placing a preform on the second mold and between the first mold and the second mold;
(C) heating the first mold and the second mold to a temperature at which the preform is capable of being press-molded;
(D) pressing the first mold and the second mold against the preform, thereby impressing the pattern of the first mold onto the preform to obtain a patterned preform; and
(E) cooling the second mold and parting the patterned preform from the first mold, so as to obtain the plate workpiece with the surface microstructures.

2. The method as claimed in claim 1, wherein the step of placing a preform between the first mold and the second mold and on the second mold comprises disposing the preform, the first mold and the second mold in a closed chamber, and the closed chamber has a pressure not more than 5×10⁻³ torr.

3. The method as claimed in claim 1, wherein the step of pressing the first mold and the second mold against the preform comprises pressing the first mold and the second mold against the preform isothermally for 60 seconds to 100 seconds.

4. The method as claimed in claim 1, wherein the preform is made of optical glass, and the step of heating the first mold and the second mold to a temperature at which the preform is capable of being press-molded comprises heating the first mold and the second mold to the temperature ranging from 350° C. to 700° C.

5. The method as claimed in claim 1, wherein the second mold has a first surface facing to the first surface of the first mold and a second surface opposite to the first surface of the second mold, and the step of cooling the second mold comprises cooling the second mold from the second surface of the second mold.

6. The method as claimed in claim 5, wherein the step of cooling the second mold comprises cooling the second mold with a cooling rate not more than 0.5° C./second.

7. The method as claimed in claim 6, wherein the step of cooling the second mold further comprises cooling the first mold with a cooling rate not more than 0.5° C./second.

8. The method as claimed in claim 5, wherein the step of cooling the second mold comprises cooling the second mold with a cooling rate not more than 0.5° C./second and secondary cooling the second mold with a cooling rate ranging from 1.5° C./second to 2° C./second to obtain the plate workpiece with surface microstructures.

9. The method as claimed in claim 5, wherein the step of cooling the second mold further comprises blowing a cooling gas to the second surface of the second mold, so as to cool the second mold, and the cooling gas comprises nitrogen, oxygen or their combination.

10. The method as claimed in claim 1, wherein the plate workpiece with the surface microstructures comprises a surface and multiple grooves formed in the surface and extending along a direction, each groove consisted of two adjacent sloping surfaces at an acute angle.

11. The method as claimed in claim 10, wherein the grooves have a mean width ranging from 105 micrometers to 195 micrometers and a width tolerance ranging from 0.2 micrometers to 0.35 micrometers.

12. The method as claimed in claim 11, wherein the grooves have a mean interval ranging from 127 micrometers to 250 micrometers between every two adjacent grooves and an interval tolerance ranging from 0.2 micrometers to 0.5 micrometers.

13. The method as claimed in claim 10, wherein the press-molding apparatus further comprises two fixing members disposed on the second mold and respectively at two opposite sides of the preform, and each fixing member has a long axis parallel to the direction of the grooves of the plate workpiece with the surface microstructures.

14. The method as claimed in claim 1, wherein the first mold and the second mold are made of tungsten carbide or tool steel.

15. The method as claimed in claim 13, wherein each fixing member has a surface near the side of the preform and a film coated on the surface of the fixing member, and the film is made of platinum-iridium alloy or diamond-like carbon.

16. The method as claimed in claim 1, wherein the first surface of the first mold has a centerline average roughness less than 20 nanometers.

17. The method as claimed in claim 2, wherein the step of pressing the first mold and the second mold against the preform comprises pressing the first mold and the second mold against the preform isothermally for 60 seconds to 100 seconds.

18. The method as claimed in claim 17, wherein the preform is made of optical glass, and the step of heating the first mold and the second mold to a temperature at which the preform is capable of being press-molded comprises heating the first mold and the second mold to the temperature ranging from 350° C. to 700° C.

19. The method as claimed in claim 18, wherein the second mold has a first surface facing to the first surface of the first mold and a second surface opposite to the first surface of the second mold, and the step of cooling the second mold comprises cooling the second mold from the second surface of the second mold with a cooling rate not more than 0.5° C./second and the first mold with a cooling rate not more than 0.5° C./second.

20. The method as claimed in claim 19, wherein the step of cooling the second mold further comprises secondary cooling the second mold with a cooling rate ranging from 1.5° C./second to 2° C./second after cooling the second mold from the second surface of the second mold with the cooling rate not more than 0.5° C./second.
